(19) United States
(12) Patent Application Publication
(10) Pub. No.: US 2024/0421487 A1
(43) Pub. Date: Dec. 19, 2024

(54) STACKED PATCH ANTENNA HAVING SPACERS

(71) Applicant: Massachusetts Institute of Technology, Cambridge, MA (US)

(72) Inventors: Pierre A. DUFILIE, Marlborough, MA (US); James P. SMITH, Chelmsford, MA (US); David J. KINDLER, Concord, MA (US); Christopher J. NUTTING, Melbourne Beach, FL (US)

(21) Appl. No.: 17/515,414

(22) Filed: Oct. 30, 2021

Related U.S. Application Data
(60) Provisional application No. 63/115,748, filed on Nov. 19, 2020.

(51) Int. Cl. H01Q 9/04; H01Q 1/16

(52) U.S. Cl. CPC H01Q 9/0414; H01Q 1/16

(57) ABSTRACT

An antenna comprises first and second substrates with one or more spacers disposed therebetween so as to provide a substantially uniform an air gap between the substrates. Disposed on the first and second substrates are one or more antenna elements and disposed on at least one of the substrates is a feed circuit.

### CROSS REFERENCE TO RELATED APPLICATION

This application claims the benefit, under 35 U.S.C. § 119 (e), of U.S. Provisional Application No. 63/115,748 filed Nov. 19, 2020 the contents of which application is incorporated herein by reference in its entirety.

### GOVERNMENT RIGHTS

This invention was made with Government support under Grant No. FA8702-15-D-0001 awarded by the U.S. Air Force. The Government has certain rights in the invention.

### FIELD

The subject matter described herein relates generally to radio frequency (RF) circuits and more particularly to stacked-patch array antennas.

### BACKGROUND

As is known in the art, it is desirable to provide array antennas which operate over a wide range of frequencies and over a wide range of scan angles.

### SUMMARY

In accordance with one aspect of the concepts described herein, a microstrip stacked patch antenna comprises first and second substrates with one or more spherically-shaped or spheroid-shaped ball spacers disposed therebetween. The spacers are disposed so as to form a substantially uniform air gap between the first and second substrates. Disposed on the first and second substrates are one or more patch antenna elements and disposed on one of the substrates is a feed circuit.

With this particular arrangement, a microstrip stacked patch antenna having a substantially uniform air gap between the first and second substrates is provided. Disposing a plurality of spherically-shaped or spheroid-shaped spacers between the two substrates enables the accurate creation of a substantially uniform air gap between first and second substrates. In embodiments, the spaces may be provided as prolate or oblate spheroids. In embodiments, the spacers may be provided as spheres (i.e. balls). In embodiments, the air gap may be thin (i.e. in the range of 0.001″ to 0.020″).

In embodiments, the one or more patch antenna elements disposed on the first and second substrates are resonant lower and upper patches.

The ball spacer concept may be applied to a wide range of different antenna designs as well as circuit designs which may benefit from a spacer structure and arrangement comprising two spaced apart substrates having an air gap therebetween. The ability to provide structures having substantially uniform air gaps may be an important characteristic is circuits/antennas operating at relatively high frequencies (e.g. frequencies in the millimeter wave frequency range).

Significantly, when a ball spacer structure is utilized in an array antenna, such a structure does not significantly degrade the performance of the array antenna. In some embodiments, when electrically conductive balls are used as the spacers, the array antenna performance may be improved.

The spacer structure and concepts described herein find use in both military and commercial applications including but not limited to communications systems, remote sensing systems, and radar systems.

In embodiments, the concepts, structures and techniques described herein relate to spacing structures suitable for use in antennas comprising a microstrip antenna. The spacing concepts, structures and techniques described herein may be well suited for use in array antennas. In embodiments, the spacing concepts, structures and techniques described find use in stacked patch antenna designs capable of achieving wide operational scan angles (e.g. scan-capable to +/−30 degrees or greater) which operate with a frequency bandwidth of about an octave. Such stacked patch antenna designs find use in a wide range of applications including, but not limited to, communications systems, remote sensing systems, and radar system.

It should, however, be appreciated that the spacer concepts, systems and techniques described herein may be used in any application requiring array antennas capable of operating over a wide range of frequencies and/or over a wide range of scan angles.

The spacer concepts, systems and techniques described herein may be used with any type of radiator and with antennas having any operational bandwidth. For example, the spacer concepts, systems and techniques described herein may be used with a stacked patch array antenna operating over an octave bandwidth and may also be used with a planar ultrawideband modular antenna (PUMA) array having a bandwidth greater than an octave and may also be used with printed dipole array antennas having a fractional bandwidth of 3:1 or greater (e.g. 5:1, 6:1 or greater bandwidths).

It should be appreciated that the concepts, systems and techniques described herein are scalable meaning that antennas provided in accordance with the described concepts, systems and techniques may operate at any frequency in the radio frequency (RF) range (e.g. the range of about 3 kHz to about 300 GHZ) assuming required manufacturing tolerances are satisfied.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a cross-sectional view of a stacked-patch antenna having first and second antenna elements with an air gap in between;

FIG. 2 is a transparent, cross-sectional view of a portion of a stacked-patch antenna array having a spherical spacer;

FIG. 3 is a transparent, isometric view of a portion of a stacked-patch antenna array having a plurality of spherical spacers;

FIG. 4 is an enlarged transparent, isometric view of a portion of a stacked-patch antenna array having a plurality of spherical spacers;

FIG. 5 is a transparent, cross-sectional view of a portion of a stacked-patch antenna array having a spherical spacer;

FIG. 6 is a top view of a stacked-patch antenna array having a plurality of spherical spacers;

FIG. 7 is a transparent, isometric view of a portion of a stacked-patch antenna array having a plurality of spherical spacers;

FIG. 8 is a plot of voltage standing wave ration (VSWR) vs. frequency over a plurality of elevation scan angles for a stacked-patch antenna array having a plurality of spherical spacers;

FIG. 9 is a plot of voltage standing wave ration (VSWR) vs. frequency over a plurality of azimuth scan angles for a stacked-patch antenna array having a plurality of spherical spacers;

FIG. 10 illustrates a plurality of spacer shapes;

FIG. 11 is an isometric view of an array antenna having ball-shaped spacers disposed in capture elements used to locate and/or secure the ball-shaped spacers.

FIG. 11A is a side view of the array antenna of FIG. 11;

FIG. 11B is an isometric view of an array antenna having reduced size ball-shaped spacers disposed between a pair of substrates;

FIG. 11C is a side view of the array antenna of FIG. 11B;

FIG. 11D is an isometric view of an array antenna having ball-shaped spacers bonded in support rings to locate and/or secure the ball-shaped spacers;

FIG. 11E is a side view of the array antenna of FIG. 11D; and

FIG. 11F is a sectional view of the array antenna of FIG. 11E.

### DETAILED DESCRIPTION

Before describing structures and techniques for providing a substantially uniform gap between the surface of two substrates in a radio frequency (RF) circuit such as an RF antenna, RF coupler, RF amplifier or any other type of passive or active RF circuit, some introductory concepts are explained.

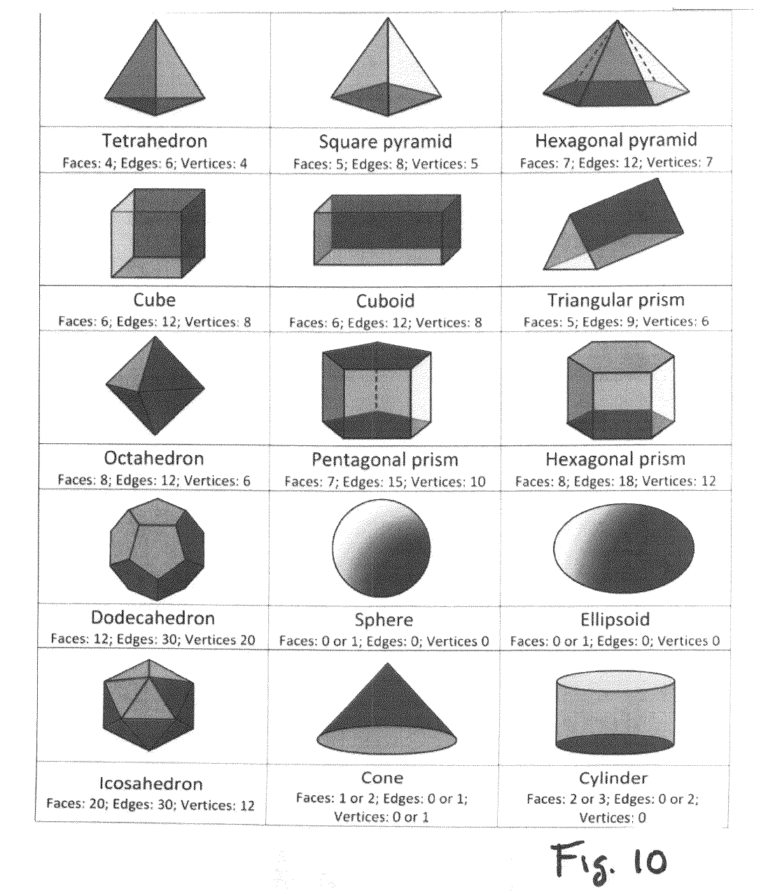

In embodiments, the spacer structure comprises a plurality of spherically-shaped (e.g. ball-shaped) or spheroid-shaped spacers disposed between the two substrates. It should be noted that the concepts sought to be protected herein are not limited to spherically-shaped or spheroid-shaped spacer elements. Rather, a wide variety of spacer element shapes are possible (as illustrated, for example, in FIG. 10). The spacer structure described herein enables the accurate creation of an air gap between first and second substrates.

The spacer structure concept described herein is described in the context of a stacked patch antenna array design and enables the accurate creation of an air gap between first and second patch antenna elements. It should, however, be appreciated that the spacer structure concepts, structures and techniques described herein may be used in any circuit structure comprising two or more substrates where it is desirable to provide a substantially uniform air gap between surfaces of the substrates. That is, the spacer structure concept described herein may be used in antennas and other RF circuits capable of operating at any frequency range.

In embodiments, the spacer concept described herein may enable the accurate creation of an air gap between two substrates with size of the air gap being in the range of about 0.001″ to about 0.020.″ This capability may be an important characteristic for at least some antennas (e.g. array antennas or antenna systems) and other circuits operating at frequencies in and above the Ka band frequency range.

The spacer concepts, structures and techniques may be used in RF circuits (including, but not limited to RF antennas) operating in a wide range of frequencies. For example, the spacer concepts, structures and techniques may be used in RF circuits operating at or above the L-band frequency range. In embodiments, the spacer concepts, structures and techniques may be used in RF circuits operating in the 60 GHz-120 GHz frequency range. In embodiments, the spacer concepts, structures and techniques may be used in RF circuits operating above a frequency of 120 GHz.

In many applications, dimensions of antenna elements and antenna element spacing are related to frequency. In general, the higher the frequency of operation, the smaller the size of antenna elements, the spacing between antenna elements and the smaller the size of an array antenna. There is thus a concomitant relationship, between operational frequencies of an antenna and antenna size and spacing between antenna elements. Consequently, above some operational frequencies, the use of structural foam as a spacer becomes impractical.

Accordingly, in one aspect, described is a concept for spacing antenna elements using a plurality (or array) of shaped spacer elements (or more simply “spacers”). In embodiments, the spacer elements may be spherically shaped (and thus may sometimes be referred to herein as “ball spacers” or “spheres”) or spheroidal-shaped elements.

In embodiments, the spherically (or other) shaped spacer elements may be arranged in an array pattern to form a so-called spacer structure. Significantly, the size and shape of the spacer elements as well as the pattern in which the spacer elements are deployed are selected such that inclusion of such a spacer structure in an array antenna, such as a stacked patch array antenna structure, does not significantly degrade (and ideally does not at all degrade) the performance of the array antenna.

In embodiments, spherically-shaped or spheroid-shaped spacer elements may be provided from an electrically conductive material. In embodiments, spacer elements may be provided from an electrically insulating material. In embodiments, the spacer elements may be provided from an insulating material having an electrically conductive material disposed on a surface thereof. In embodiments, a plurality of different spacer structures may be used to a forma spacer structure (i.e., not all spacer elements in a spacer structure need be provided from the same material, nor is it required that all spacer elements in a spacer structure have the same shape).

Rather, the details of the spacer elements (e.g. particular size, shape and materials from which a spacer is made) depend upon a variety of factors including but not limited to frequency of operation, antenna scan angles, antenna design. In embodiments, the spacer element may be provided from a ceramic material. In embodiments, the spacer elements may be provided from materials having a coefficient of thermal expansion (CTE) which is substantially the same as the CTE of the antenna substrate and/or the CTE of substrate of on which an antenna feed is disposed. In embodiments, it may be desirable to provide the spacer elements from a material that does not substantially affect antenna performance. It may be desirable to provide the spacer elements having a size and shape that does not substantially affect antenna performance. It may be desirable to provide an antenna having a number and location of spacer elements that does not substantially affect antenna performance. In embodiments, the spacer elements may be provided from a metallic material, or a metallic coating over an insulating material, such as ceramic. In embodiments, when metallic balls are used as the spacer elements, antenna performance may be improved.

For example, in some antenna applications it may be possible to improve active impedance depending upon selected sphere characteristic.

In embodiments, the concept of using an array of spacer elements described herein enables the creation of a substantially uniform air gap between first and second substrates.

In embodiments, the spacer element concept described herein may be applied to a microstrip stacked patch antenna array design and enables the creation of an air gap between first and second patch antenna elements. In embodiments, the first and second patches may correspond to resonant lower and upper patches in a stacked patch array antenna.

The spacer concept described herein finds use in both military and commercial applications including, but not limited to finding use in RF circuits configured for use in communications systems, remote sensing systems, and radar systems.

It should be appreciated that features, concepts, systems and techniques described herein find use in array antennas for any application including, but not limited to space-based, airborne, ground-based, water-based applications, radar applications, communication applications, phased array antenna applications and remote sensing applications.

In the description that follows, various features, concepts, structures, systems and techniques for providing a uniform gap between substrates using an array of spacer elements are described in the context of a stacked-patch array antenna. The uniform gap between substrates is achieved via a spacer structure disposed between the two substrates. It should be appreciated that the spacer structure, concepts, systems and techniques may also be used with other types of planar or conformal radiating structures and surfaces as well as other types of planar or conformal RF circuits.

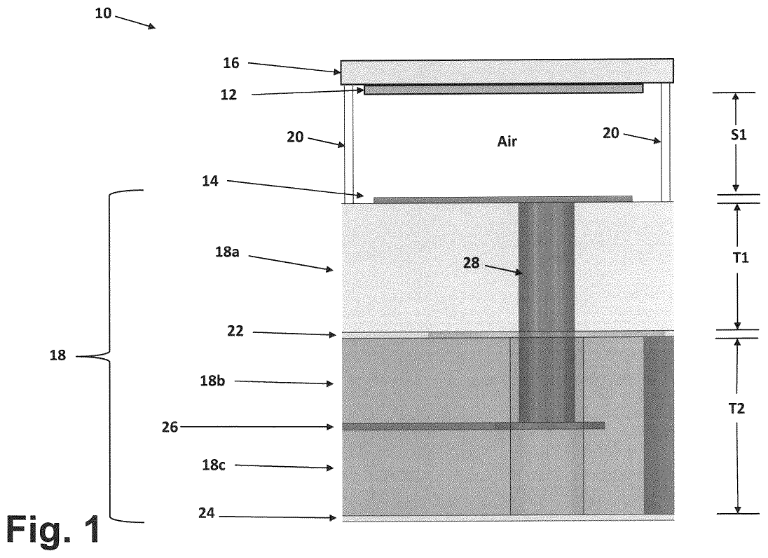

Referring now to FIG. 1, antenna 10 has first and second antenna elements 12, 14 spaced apart by a distance (or spacing) S1 with the spacing here being an air gap between the first and second antenna elements. In this example embodiment, antenna 10 comprises a first carrier substrate 16 substrate (e.g. a printed circuit board (PCB)) having the antenna element 14 disposed on a surface thereof. Thus, in this example embodiment, antenna element 14 is provided as a first (or upper) microstrip patch antenna element (or more simply microstrip patch 14).

Similarly, antenna 10 comprises a second carrier substrate 18a (e.g. a second PCB) having the antenna element 14 disposed on a surface thereof. Thus, in this example embodiment, antenna element 14 is provided as a second (or lower) microstrip patch antenna element (or more simply microstrip patch 14).

Thus, in the example embodiment of FIG. 1, antenna 10 comprises a first patch antenna element arranged (or stacked) over a second patch antenna element and thus antenna 10 may be referred to as a so-called “stacked-patch antenna.”

In embodiments, the PCB carrier substrate 16 may be provided as Rogers Duroid 5880 having a thickness of about 5 mils (i.e., 0.005″), the first antenna element may be an upper microstrip patch provided from an electrically conductive material (e.g. copper having a thickness of 0.7 mil) and disposed on a surface of substrate 16. Although illustrated as a single substrate, in embodiments, the first carrier substrate may be provided from a plurality of substrates.

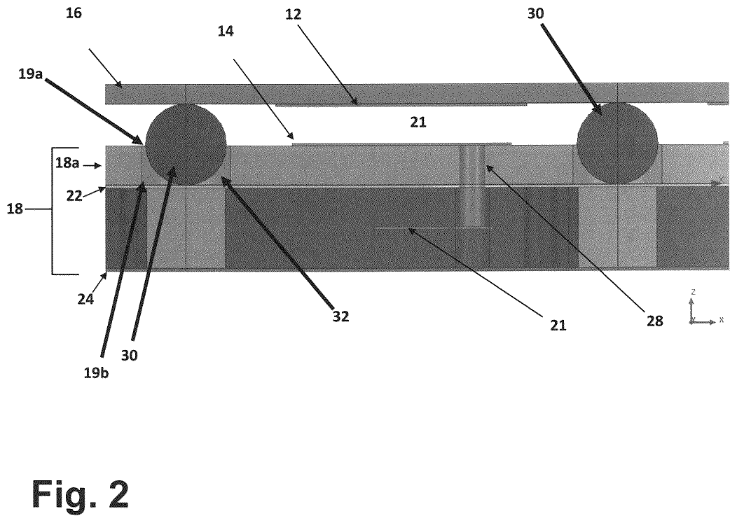

Antenna element 14 may be provided as a second (or lower) patch disposed over a surface of a portion of substrate 18 (here designated 18a) such that an air gap exists between the facing surfaces of the first and second substrates and thus between the upper and lower patch antenna elements 12, 14. The manner in which this air gap may be provided will be described below in conjunction with FIGS. 2-7. Briefly however, one or more spacer elements 20 (or more simply “spacers” 20) are disposed to space antenna elements 12, 14 by the distance S1 (i.e. an air gap 21).

The second substrate 18 (which may itself be provided from a plurality of substrates here illustrated as substrates 18a, 18b, 18c) has ground planes 22, 24 disposed on opposing surfaces thereof (with the ground plane 22 being on a surface of a substrate—in this example, substrate 18a—opposite the surface on which the antenna element 14 is disposed). Although second substrate 18 is here illustrated as comprising a plurality of substrates, in embodiments, substrate 18 may be provided as a single substrate.

The second substrate comprises a signal path 26 (here, implemented as a stripline signal path) coupled to a first end of a vertical signal path 28 (also referred to as “probe feed circuit” 28 or more simply a “probe feed” 28). In embodiments, probe feed 28 may be implemented as a conductive via. A second end of vertical signal path 28 is coupled to antenna element 14 (i.e. a second end of the probe feed is coupled to the second patch antenna element and thus the second patch antenna element is sometime referred to as an active patch element. It should, of course, be appreciated that there a large variety of techniques which may be used to feed (or couple) a signal to and/or from antenna element 14 including but not limited to capacitive feed circuits). After reading the disclosure provided herein, one of ordinary skill in the art will appreciate how to select a particular feed circuit for use in with a particular antenna element configuration and/or a particular application.

In embodiments, one, some or all of substrates 18a, 18b and/or substrate 18c may be provided as a low temperature co-fired ceramic (LTCC) substrates having a relative dielectric constant (ϵᵣ) of about 5.6 and substrate 18a may be provided having a thickness T1 of about 0.010″ and the combined thickness T2 of substrates 18b, 18c may be about 0.0207″.

It should be appreciated that the dimensions shown in FIG. 1 are illustrative only for a stacked-patch antenna operating in a frequency range of about 60 GHz to about 200 GHz and more particularly for a stacked-patch antenna operating in a frequency range of about 60 GHz to about 70 GHz.

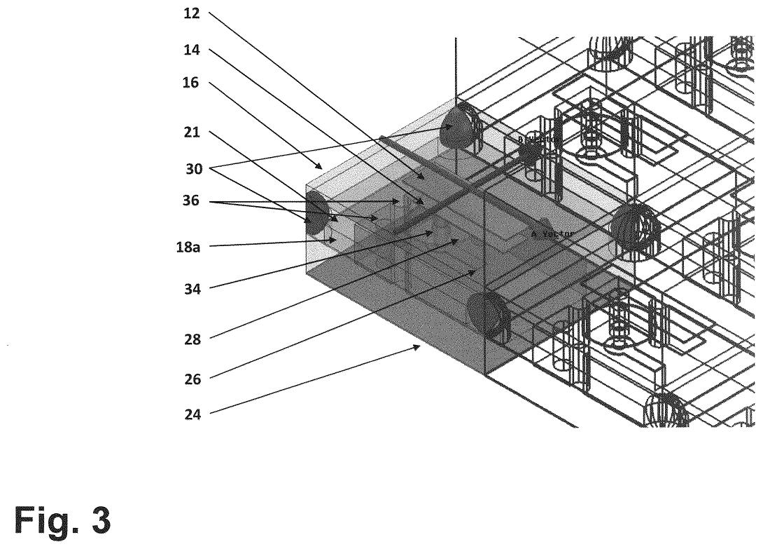

Referring now to FIGS. 2 and 3 in which like elements of FIG. 1 are provided having like reference designations are provided having like reference designations, a stacked-patch antenna 10 has first or upper patch antenna element 12 disposed on first substrate 16 and second (or lower) patch antenna element 14 disposed on second substrate 18 and one or more spacer elements (or more simply “spacers”) 30 disposed to separate (or space) the first substrate (and thus the first antenna element) from the second substrate and (thus the second antenna element).

In the example embodiments of FIGS. 2 and 3, the spacer elements are provided having a spherical (or ball) shape. The ball-shaped spacers may be provided from glass and/or ceramic and/or metallic materials. In short, any material from which a precision spacer may be formed may be used. Ideally, the ball-shaped spacers may be provided from a material capable of being manufactured to provide a ball spacer having a diameter tolerance in the range of about 0.000005″. Thus, in embodiments so-called Grade 3 or Grade 5 ball spacers (e.g. ball bearings) may be used.

It should, of course be appreciate that in some embodiments, such small tolerance (e.g. such as that provided by a Grade 3 or 5 ball bearing) may not be required. For example in some embodiments, spacers having tolerances in the range of about one-tenth of a mil may be acceptable (i.e. the tolerance in dimensions of each spacer may be about one-tenth of one mil). For example, in cases in which a sphere-shaped spacer is used, the spacers may have a specified diameter +/−about one-tenth of one mil.

Thus, depending upon the needs of a particular application, spacers having a wide range of tolerances may be used. For example, in one application sphere-shaped spacers having substantially the same tolerances as a Grade 5 ball bearing may be used while in another application sphere-shaped spacers having tolerances of about one-tenth or one mil or even larger may be used.

It should be noted that the spacer elements may be provided using any subtractive or additive manufacturing technique including any mechanical or chemical technique.

The particular diameter of ball-shaped spacers may be selected in accordance with a variety of factors including but not limited to the dimensions of the RF circuit (e.g. the antenna) in which the spacers are used and the frequency of operation of the circuit (e.g. the operating frequency of the stacked patch antenna). Those of ordinary skill in the art will appreciate how to select a ball spacer diameter for use in a particular application.

In some embodiments, to dispose a spherical spacer in a substrate (e.g. substrate 18), an opening, depression or hole 32 may be provided (e.g. formed, cut or otherwise provided) in one or both of the upper or lower substrates. In the example of FIG. 2, an opening is provided in a portion of the lower substrate 18 and is provided as an opening which extends entirely through the lower substrate (i.e. in the example of FIG. 2, the opening 32 is a through-hole extending from a first surface of the substrate to a second substrate surface such that a diameter of an aperture 19a of the opening on one surface of the substrate is the same as a diameter of an aperture 19b of the opening on the opposite surface of the substrate). In other embodiments, the opening 32 may not extend entirely through the substrate. In embodiments, the opening may extend only partially through the substrate. In embodiments, only a portion of the opening may extend entirely through the substrate (e.g. a diameter of an aperture 19a of the opening on one surface of the substrate may be different than a diameter 19b of an aperture of the opening on an opposite surface of the substrate). The upper ground plane is electrically coupled to a lower ground plane. In the example of FIG. 2, a conductive via couples the upper ground plane to a lower grand plane. A ground plane (denoted as an upper ground plane in FIG. 2) is disposed over the second surface of the substrate. In some embodiments, a conductive spacer (e.g. a conductive ball) may act as a conductive via between layers.

In some embodiments, the substrate opening in which the spherical spacer is disposed has a diameter which is greater than the diameter which is greater than the diameter of the spherical spacer. In some embodiments, the substrate opening 32 in which the spherical spacer is disposed has a diameter which is substantially equal to the diameter of the spherical spacer.

It should be appreciated that although the spacers are here illustrated as sphere shaped, other shaped spacers may also be used including but not limited to spheroidal shaped, regular shaped (including but not limited to cube shaped, pyramidal shaped, cone shaped, cylinder shaped, rectangular prism shaped, triangular prism shaped) as well as irregular shaped spacers. Some example shapes are illustrated in FIG. 10. The particular spacer shape to use in any particular application will be selected to suit the needs/requirements of the application.

Factors to consider in selecting spacer shape include, but are not limited to, shapes that enhance signal and/or attenuate as desired, volume of a spacer shape, ability to accurately locate a spacer or a plurality of spacers, and/or mechanical/structural considerations.

It will, of course, be appreciated that the shape of the openings in the upper and/or lower substrate are selected to accept the shape of the spacer being disposed therein. That is, the substrate openings may preferably be provided having a shape corresponding to the shape of the spacer being disposed therein. Thus, if a spacer having a substantially rectangular-cross sectional shape is used, then the substrate openings in which the spacers are to be disposed are also preferably provided having a substantially rectangular-cross sectional shape.

It should also be appreciated that it is not necessary that all spacers have the same shape. Thus, in some embodiments, the spacers and/or the substrate openings in which the spacers are disposed may have different shapes.

It should also be appreciated that, depending upon the shape of the spacer element, in some cases no substrate openings are needed while in other cases openings in both substrates (e.g. upper and lower substrates) may be desired or required.

In embodiments, the stacked-patch antenna is designed to detect (i.e. receive) and/or transmit RF signals between a first frequency and a second frequency within a radio frequency (RF) band. The first frequency, referred to herein as f₁, may be associated with a corresponding wavelength, referred to herein as λ₁ or simply λ, by the well-known formula λ₁=c/f₁ where c=299,792,458 m/s is the speed of light in a vacuum. In embodiments, the first and second frequencies may be separated by at least an octave; that is, the second frequency may be at least twice the first frequency.

It is appreciated that the frequencies (respectively wavelengths) of radiation to which the disclosed antenna is responsive, scale linearly with the dimensions of the antenna. That is to say, if each linear dimension of the antenna is multiplied by a factor M (where M is any real number), then the wavelengths detectable by the antenna are multiplied by the same factor M and the frequencies detectable by the antenna are divided by the same factor M. A person of ordinary skill will understand how to scale the antenna to achieve a desired frequency octave for detecting radiation in accordance with an associated use.

The upper patch antenna element may be any conductor, such as copper. The combination of the substrates and associated patch antenna elements together provide the stacked-patch antenna.

Although the antenna of FIGS. 2 and 3 comprises two radiator layers, in embodiments the antenna may comprised a radiator on only one layer. Also, in other embodiments, the antenna may comprise more than two layers with radiators disposed on one, some or all of the layers and comprising spacers disposed between some one or all of the layers.

In embodiments, spacers may be disposed in a cage so as to locate one or more of the spacers. In embodiments, multiple layers which contain features either disposed on or integrated into one or more layers which locate spacer elements in x-y dimensions may be used.

As may be seen in FIG. 3, the ground plane may be provided having openings (or “reliefs”) 34 to accept probe-type feeds (e.g. pin feeds). Thus, each antenna element may be fed from one or more pins disposed through respective ones of ground plane reliefs such that each antenna element fed with two orthogonal polarizations (e.g. vertical and horizontal polarizations). As may also be seen in FIG. 3, ground vias 36 may extend between various portions of conductors in the substrate 18 (e.g. between ground plane 24 and conductor 22).

Those of ordinary skill will appreciate that other types of feed structures may also be used including, but not limited to, capacitive feed structures. Those of ordinary skill in the art will understand how to select a feed circuit which is appropriate to suit the needs of a particular application.

Stacked patch antenna array structures are capable of operation over a bandwidth which is wider than a single level antenna with little or no increase in physical size. In some embodiments, the antenna elements used in the stacked patch antenna array may be configured for operation in different frequency bands and/or different polarizations. For example, as explained above, the linear dimensions of the antenna may be scaled to achieve a desired frequency octave for detecting radiation in accordance with an associated use.

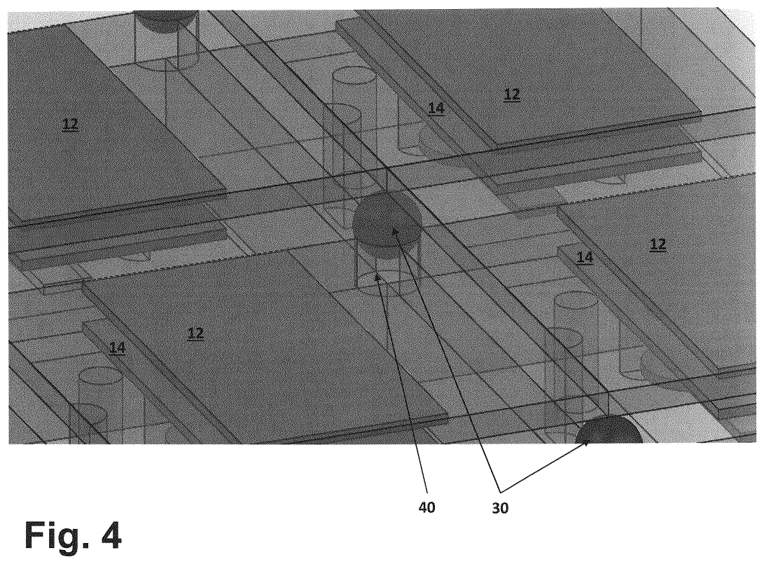

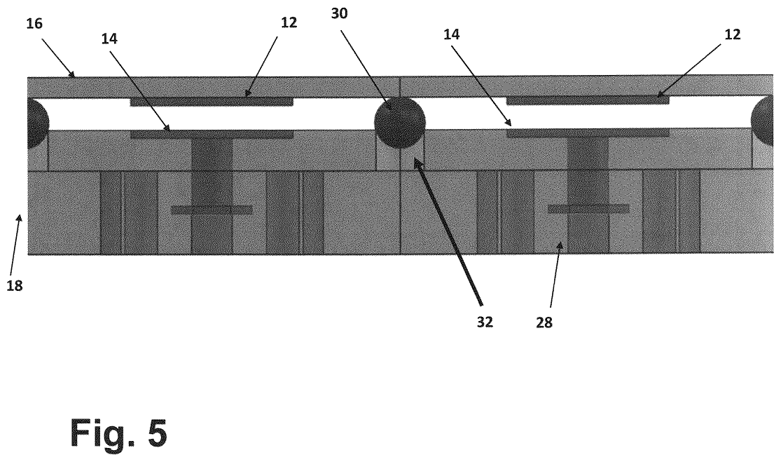

Referring now to FIGS. 4 and 5 in which like elements of FIGS. 1-3 are provided having like reference designations, a cup-shaped opening (or recess with a curved opening) 40 is provided in at least one of the upper and lower substrates to accept a spherical spacer. It should be noted that in the embodiment of FIG. 5, the tolerance of the opening (or hole or recess) in which spherical spacer element is disposed will be a factor in the determining the distance between the facing surfaces of the upper and lower substrates. This is because the diameter of each opening has a tolerance and thus the spherical spacer elements may not “sit” in the respective openings at precisely the same way. That is, when the opening is at its largest possible size (i.e. at the largest size diameter resultant from a given tolerance) the spherical spacer element will sit deeper (i.e., be recessed further) into the opening than a spacer element disposed in an opening having the smallest possible size (i.e. having the smallest size diameter resultant from the given tolerance). It should also be appreciated that the opening 32 in in FIG. 5 may be a thru hole or a depression in the substrate.

This is in contrast to the example embodiment of FIG. 2 in which the ball spherical spacer element is illustrated as being disposed in a through hole having a diameter which is larger than the diameter of the spherical spacer element such that the spherical spacer element is disposed on a surface of the substrate, as shown.

From an electrical standpoint, there is no substantial difference as to how the spacer element is arranged on the substrate (e.g. the approaches in both FIGS. 2 and 5 are electrically equivalent). In practice, one may simply use the best approach for a particular fabrication technique (which may depend on the material from which the layers are provided. In other embodiments spacer elements can simply be arranged and/or secured (e.g. bonded) directly on substrate surfaces (rather than using an opening or other substrate feature to properly locate (i.e. in x-y directions) and/or hold spacer elements in a desired location on a substrate. In embodiments, spacer elements may be bonded to a first (or top) surface of the lower substrate before the upper substrate is disposed over the lower substrate.

Thus, some embodiments described herein utilize an array of “through holes” that locate the spacer sphere's laterally, and achieve the air gap 21 with the spheres contacting a top and bottom layer that are also part of the overall device structure. So the spacing is determined by the sphere diameter. And such a structure requires at least 3 layers (i.e. a top layer containing the patch radiator array, a middle, “cage” layer that holds the spheres, and a bottom layer with additional RF structure, strip lines, feed circuits, etc.). Use of the ball spacers allows one to achieve a consistent air gap (i.e. an even air gap) between the upper and lower patch elements. In embodiments, the ball spacers allows one to achieve a substantially constant 10 mil air gap between the upper and lower patch elements.

As shown in FIGS. 4 and 5, a two-layer air-gap forming architecture (i.e. two substrates 16, 18 with air in between) is also possible. The spheres forming the air gap need not sit only between two wafers and captured laterally by a third “cage” element. Etched precision pockets in one or both wafers can be used to hold the spacer spheres 30 (thereby eliminating the “cage” layer). Since the patch radiator device is may be constructed with a wafer fabrication process, precision holes can be patterned and etched to well-controlled photolithographic tolerances. Holes 32 (i.e. openings or depressions in a substrate) smaller than the spacer sphere diameter can serve as precision seats for an array of the spheres. If the substrate comprises a non-silicon wafer material, deep-reactive ion etch would be a suitable process for forming precision round pockets. If the wafer material is single-crystal silicon, then anisotropic etch with KOH is an additional method for forming precision pyramidal cavities. Partial depth cavities also enable lateral alignment of the spaced-apart wafer structures in addition to precision air gap Z control.

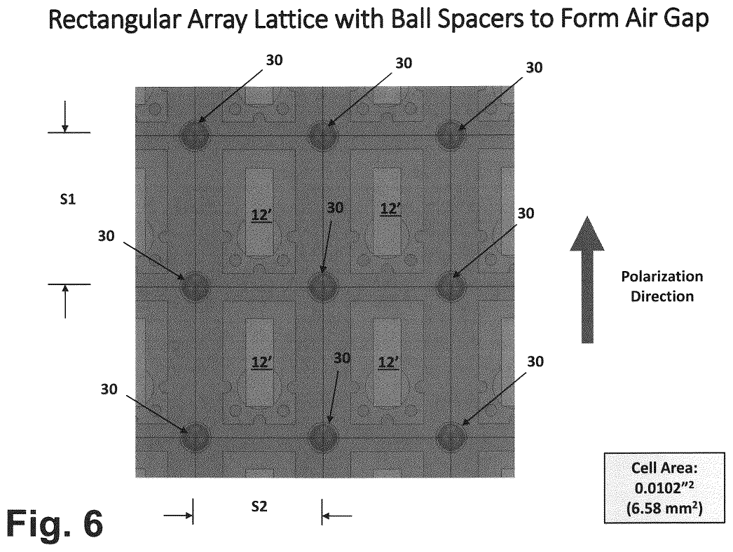

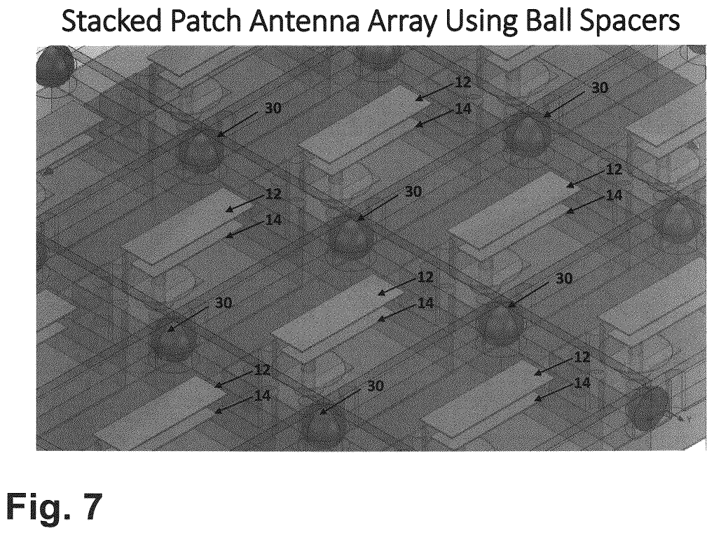

Referring now to FIGS. 6 and 7 in which like elements are provided having like reference designations, a portion of a stacked-patch antenna array having a rectangular antenna element lattice spacing includes spacers (here illustrated as spherical spacers) disposed in a rectangular grid pattern between first and second substrates so as provide a substantially uniform air gap between surfaces of the first and second substrates. In this embodiment the spacers have a center-to-center spacing of S1 in the vertical direction and a center-to-center spacing of S2 in the horizontal direction. In embodiments, S1 may be about 0.110 inch and S2 may be about 0.093 inch. Since the first and second substrates have respective ones of first and second patch elements disposed therein, the ball spacers also provide a uniform air gap between the first and second patch elements.

In embodiments, the spacer elements may be disposed in a number of different patterns. For example spacer elements may be disposed in a triangular grid pattern, or any other lattice shape or any polygonal shape may be used.

In considering what pattern to dispose the spacer elements, a number of factors, including but not limited to, active input impedance over scan angle, mechanical considerations, moving vs. stationary platform. For example an antenna (or other RF circuit) comprising spacer elements disposed on a moving platform (such as a missile) may be subject to g-forces and thus may require more spacer elements (so as to provide more mechanical support) than the same (or a similar) antenna (or other RF circuit) disposed on a stationary platform such as a cell phone tower.

It should be appreciated that all of the factors/considerations mentioned herein (e.g. array antenna shape, type of antenna element, materials, etc.) may be considered in selecting spacer element characteristics (e.g. number of spacer elements to use in an application, spacer element shape, spacer element materials, etc.)

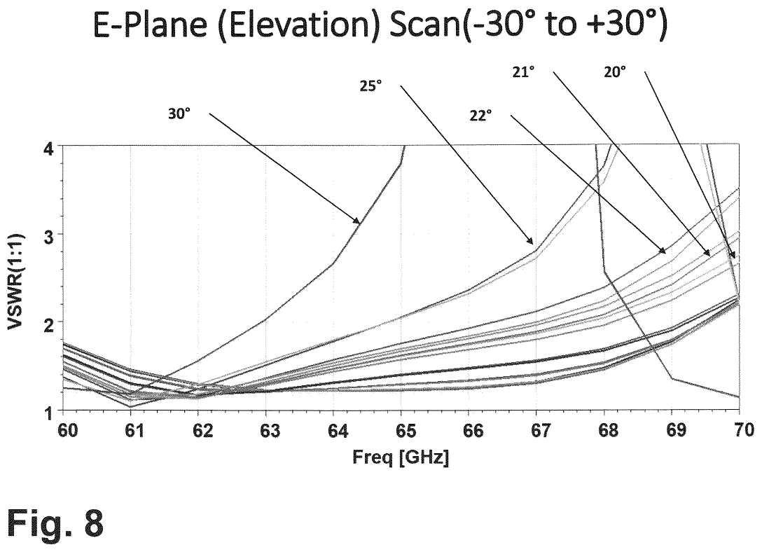

FIG. 8 (for antenna shown in FIG. 6) is a plot of voltage standing wave ration (VSWR) vs. frequency over a plurality of elevation scan angles (E-plane scan angles) for a stacked-patch antenna array having a plurality of ball spacer.

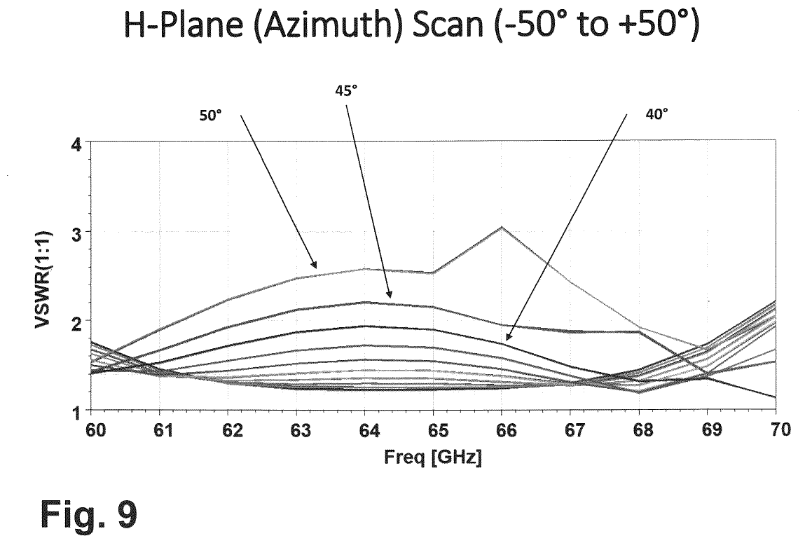

FIG. 9 (for antenna shown in FIG. 6) is a plot of voltage standing wave ration (VSWR) vs. frequency over a plurality of azimuth scan angles (H-plane scan angles) for a stacked-patch antenna array having a plurality of ball spacers.

Referring now to FIG. 10, at least some illustrative spacer shapes are shown. Variants of these shapes are, of course, possible. Openings in the substrate may also be provided having any of these shapes. In embodiments, the spacers and openings may have different shapes, substantially the same shape or complementary shapes. In embodiments, portions of the spacer elements (e.g. surfaces of the spacer elements) may have a shape complementary to the shape of a portion of the opening.

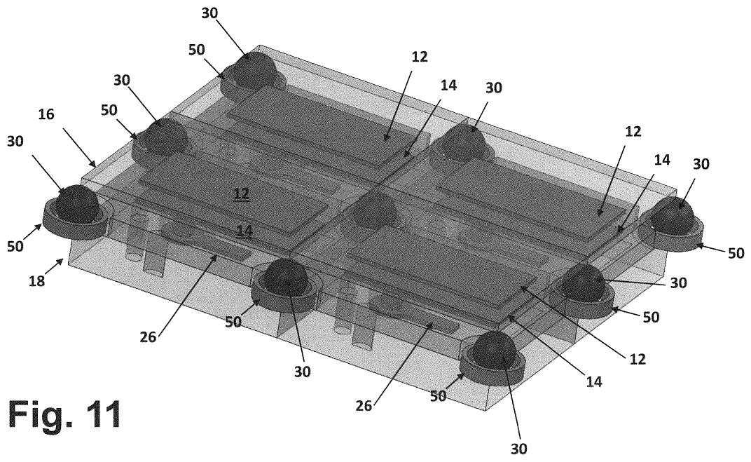

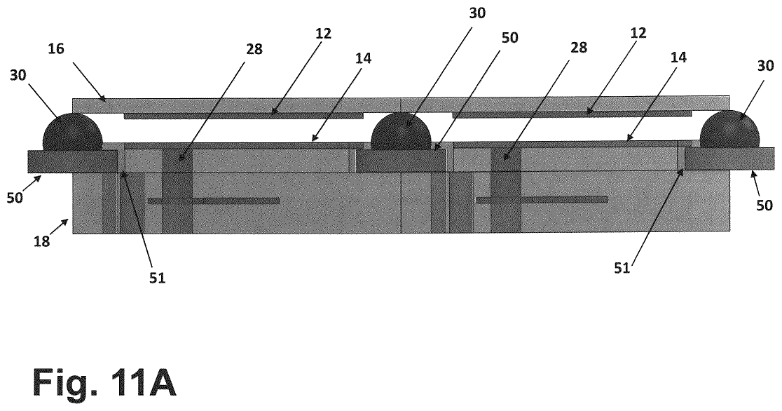

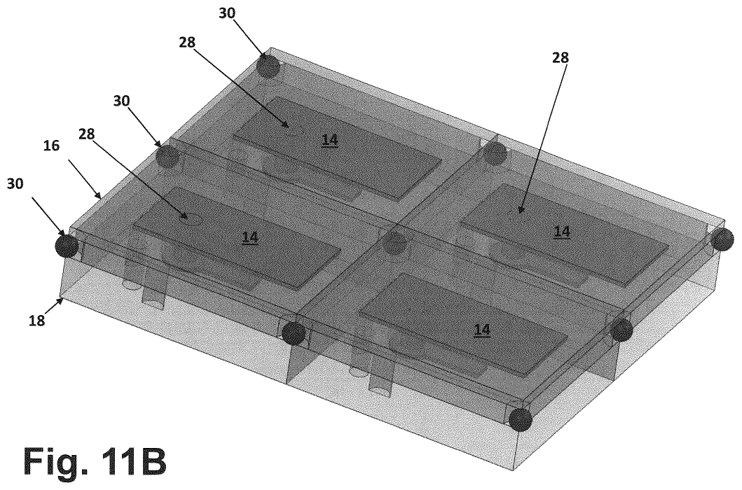

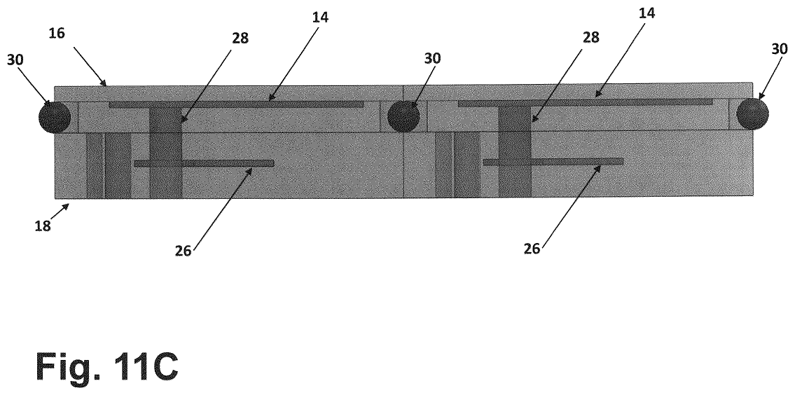

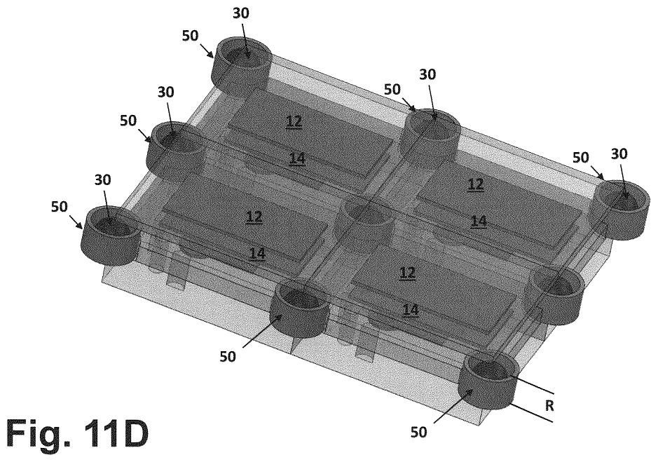

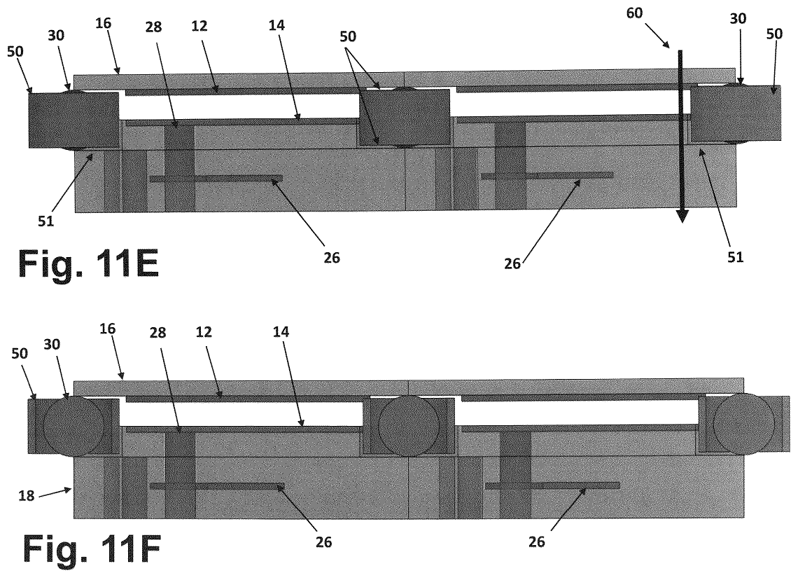

Referring now to FIGS. 11 and 11A, in which like elements of FIGS. 1-7 are provided having like reference designations, ring-shaped elements 50 are disposed on a surface of a substrate 18. A spherical spacer element 30 is disposed in the ring. The ring-shaped element and spacer are fabricated having respective tolerances selected to meet the needs of the particular application. In some embodiments the spacer and ring-shaped element may have the same mechanical tolerance. In some embodiments the spacer and ring-shaped element may have different mechanical tolerances. The particular size and shape of the ring-shaped element and the spacer element are selected such that the ring-shaped element locates (or “captures”) the spherical spacer element in a desired location on the substrate (and, of course, the spacer dimensions are selected so as to form and air gap between the substrates 18, 18 and space apart antenna elements 12, 14 by a desired distance.

As illustrated in the example embodiment of FIGS. 11, 11A and as may be most clearly seen in FIG. 11A) substrate 18 has a recess portion and ring-shaped elements 50 is disposed on a surface of the substrate recess region.

In the embodiment of FIGS. 11B, 11C, an antenna includes antenna elements 14 disposed on a surface of substrate 16 with probe feds coupled thereto. Showing smaller sphere directly spacing adjacent layers (vs. previous embodiment where sphere is contained within a layer)***

The embodiment of FIGS. 11D-11F, illustrate an antenna having dual stacked antenna elements 12, 14 and a bonding support ring with spacer spheres disposed therein. This example embodiment illustrates a technique for achieving air gap precision between substrates while also fabricating an antenna structure which is mechanically stronger than antenna embodiments including only spacer spheres disposed between a pair of substrates.

In this example embodiment the rings 50 are just shorter than a spacer dimensions which sets the size of the air gap between the substrates. In the example embodiment of FIGS. 11D-11F, the spacer is provided having a spherical shape and thus a height of the ring R, should be less than a diameter of the spherical shaper. The amount by which the height of the ring R should be less than the diameter of the spherical shaper should be substantially equal to the desired glue thickness. A glue, high shrink epoxy or other adhesive (collectively referred to herein as adhesive) may be used to fill gap regions on top and bottom of the rings. It is noted that the rings 50 have much more bonding surface area than apexes of sphere spacer elements. Adhesive shrinkage helps assure surfaces contact the sphere apexes for reliable air gap control. Adhesive on sphere apexes naturally squeezes out because of point contact between sphere and planar surfaces. It should be appreciated that the ring height R need only be toleranced to a conventional machining accuracy.

Thus, in the example embodiment of FIGS. 11D-11F a structure 50 (here a hollow cylinder or ring-shaped structure) is disposed about ball-shaped spacer elements 30. In this example, the hollow cylinder has an opening larger than the ball diameter and a height that is less than (and preferably just shy of) the ball diameter. As illustrated in FIG. 11E, the top and bottom surfaces of the cylinder become adhesive bonding surfaces (or solder reflow, etc.). Thus, the spherical spacer elements (i.e. the balls) govern the air gap (e.g. the spheres set the spacing), but the glue surface area is much larger than ball apexes (i.e. the top and bottom surfaces of rings enhance bonding).

In embodiments, shrinkage of the adhesive may act to compress the assembly together. Alternatively, mechanical fasteners could also pull the layers together to squeeze against the ball interfaces (i.e. in addition to any other mechanism for securing the various components of the antenna, mechanical fasteners may be used to compress the layers against spheres).

One could also create recesses (or “counterbores”) in one or both substrates (e.g. LTCC outermost layers 16, 18) for lateral alignment of the cylinders further adding structural strength to the assembly (i.e. it would be a “punched-out” ring in the LTCC, so ball would sit at the topmost level, but the support cylinder would be recessed one layer). Such a recess is shown in FIGS.

Variants of such “capture elements” (e.g. various shapes and specific structures) are, of course, also possible. For example, a triad of balls may be as a capture element (or locator) for spacer balls. In embodiments, each of the balls in the triad, may have a diameter which is less than the diameter of the spacer ball.

The embodiments of at least FIGS. 11A, 11D-11F illustrate a technique for adding structural support without sacrificing air gap precision. The general concepts is to surround at least some (and possibly all) spacer elements (e.g., ball-shaped spacer elements) with a wall (e.g. which may be provided as a hollow cylinder having a height that is less than (and ideally just shy of) the ball diameter. The top and bottom of the cylinder become adhesive bonding surfaces (or solder reflow, etc.). So the balls govern the air gap, but the glue surface area is much larger than ball apexes. Shrinkage of the adhesive acts to compress the assembly together.

Alternatively as illustrated in FIG. 11E, mechanical fasteners 60 could be disposed through the substrates so as to compress (or “pull”) the layers together to squeeze against the ball interfaces. One could also create “counterbores” in the LTCC outermost layers for lateral alignment of the cylinders further adding structural strength to the assembly (i.e., such an embodiment would be a “punched-out” ring in the LTCC, so ball would sit at the topmost level, but the support cylinder would be recessed one layer)

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary layers or structures at the interface of the two elements.

As used herein, the terms “optimal,” optimized,” and the like do not necessarily refer to the best possible configuration of an antenna to achieve a desired goal over all possible configurations, but can refer to the best configuration that was found during an optimization procedure given certain limits of the procedure.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value. The term “substantially equal” may be used to refer to values that are within +20% of one another in some embodiments, within +10% of one another in some embodiments, within +5% of one another in some embodiments, and yet within +2% of one another in some embodiments.

The term “substantially” may be used to refer to values that are within +20% of a comparative measure in some embodiments, within +10% in some embodiments, within +5% in some embodiments, and yet within +2% in some embodiments. For example, a first direction that is “substantially” perpendicular to a second direction may refer to a first direction that is within +20% of making a 90° angle with the second direction in some embodiments, within +10% of making a 90° angle with the second direction in some embodiments, within +5% of making a 90° angle with the second direction in some embodiments, and yet within +2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An antenna comprising:
a first substrate having first and second opposing surfaces;
a first antenna element disposed on a first one of the first and second opposing surfaces;
a second substrate having a first surface disposed over a first one of the first and second surfaces of the first substrate;
a second antenna element disposed on a first one of the first and second opposing surfaces of the second substrate;
a plurality of openings provided in one of the substrates;
a plurality of spacers disposed in respective ones of the plurality of openings such that the plurality of spacers are disposed between the first and second substrates and arranged to provide an air gap between the first surface of the second substrate and the first one of the first and second surfaces of the first substrate and second antenna elements.

2. The antenna of claim 1 wherein the plurality of spacers are disposed in a geometric pattern between the first and second substrates.

3. The antenna of claim 1 wherein the plurality of spacers are disposed in a geometric grid pattern between the first and second substrates.

4. The antenna of claim 1 wherein the plurality of spacers are disposed in one of:
a triangular grid pattern between the first and second substrates;
a polygonal pattern between the first and second substrates;
a hexagonal pattern between the first and second substrates;
a rectangular pattern between the first and second substrates;
a square pattern between the first and second substrates; and
a circular pattern between the first and second substrates.

5. The antenna of claim 1 further comprising first and second ground planes with one or more grounding vias extending from the first ground plane to the second ground plane.

6. The antenna array of claim 1, wherein the plurality of patch elements are configured for operation in different frequency bands, or in different polarizations, or both.

7. The antenna of claim 1 wherein the spacers are provided having a least one of:
(a) a spherical shape;
(b) a spheroidal shape;
(c) a diamond shape;
(d) a core shape;
(e) a pyramid shape;
(f) a cylindrical shape; and
(g) a cube shape.

8. The antenna of claim 1 wherein the antenna element is a patch antenna element.

9. An antenna comprising:
a first substrate having first and second opposing surfaces;
a second substrate having first and second opposing surfaces with a first one of the first and second surfaces of the second substrate disposed over a first one of the first and second surfaces of the first substrate;
a plurality of holes provided in one of the first and second substrates;
a first antenna element disposed on a surface of a first one of the first and second substrates; and
a like plurality of ball-shaped spacers, with respective ones disposed in a respective one of the plurality of the holes such that the ball-shaped spacers are disposed between the first and second substrates and arranged to space a surface of the first substrate from a surface of the second antenna element.

10. The antenna of claim 9 wherein the plurality of spacers are disposed in a geometric pattern between the first and second substrates.

11. The antenna of claim 9 wherein the plurality of spacers are disposed in a geometric grid pattern between the first and second substrates.

12. The antenna of claim 9 wherein the plurality of spacers are disposed in one of:
a triangular grid pattern between the first and second substrates;
a polygonal pattern between the first and second substrates;
a hexagonal pattern between the first and second substrates;
a rectangular pattern between the first and second substrates;
a square pattern between the first and second substrates; and
a circular pattern between the first and second substrates.

13. The antenna of claim 9 further comprising first and second ground planes with one or more grounding vias extending from the first ground plane to the second ground plane.

14. The antenna array of claim 9, wherein the first antenna element is a first one of a plurality of antenna elements.

15. The antenna array of claim 9, further comprising a second antenna element disposed on a second one of the first and second substrates.

16. The antenna array of claim 15, wherein the first antenna element is a first one of a plurality of first antenna elements.

17. The antenna array of claim 16, wherein the second antenna element is a first one of a plurality of second antenna elements.

18. The antenna of claim 9 wherein the plurality of holes provided in one of the first and second substrates are through holes.

19. The antenna of claim 9 wherein the plurality of holes provided in one of the first and second substrates are recesses.

20. An antenna comprising:
a first substrate having first and second opposing surfaces;
a first antenna element disposed on a first one of the first and second opposing surfaces;
a second substrate having a first surface disposed over a first one of the first and second surfaces of the first substrate;
a second antenna element disposed on a first one of the first and second opposing surfaces of the second substrate;
a plurality of openings provided in one of the substrates;
a plurality of spacers disposed in respective ones of the plurality of openings such that the plurality of spacers are disposed between the first and second substrates such that the spacing between the first and second antenna elements comprises an air gap.
